(19) United States
(12) Patent Application Publication
(10) Pub. No.: US 2007/0074795 A1
(43) Pub. Date: Apr. 5, 2007

(54) Neoprene ice bucket cover

(76) Inventor: Lisa Palmer Moore, Mt. Pleasant, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/243,902

(22) Filed: Oct. 5, 2005

(51) Int. Cl. A61J 9/08; B65D 30/16

(52) U.S. Cl. 150/154; 383/104; 215/11.6

(57) ABSTRACT

An ice bucket cover includes: (a) a substantially circular bottom wall; (b) a substantially cylindrically-shaped cover side wall attached at a bottom side wall edge to a periphery of the bottom wall, the side wall being made of a stretchable neoprene material; (c) a substantially circular, open top; (d) at least two same-sized ice bucket handle holes on opposite sides of the ice bucket cover; and (e) at least two pull tabs affixed to a top side wall edge of the ice bucket cover above the bucket handle hole, each pull tab being on an opposite side from the other pull tab; wherein the ice bucket cover is sized to closely fit over an outside surface of an ice bucket. Also included is a neoprene ice bucket cover pouch for enclosing and carrying an ice bucket, including: (a) the bottom wall; (b) the cover side wall attached at a bottom side wall edge to a periphery of the bottom wall, extending substantially perpendicularly from the bottom wall, and extending a substantial distance beyond an upper edge of the ice bucket; and (c) a closure mechanism for closing a top side wall edge of the pouch; wherein the ice bucket cover pouch has a substantially circular, open top when in an open position, the pouch being sized to closely cover an outside surface of the ice bucket.

### CROSS REFERENCE TO RELATED DOCUMENT

This invention was described in Disclosure Document Number 571171, which was received by the U.S. Patent & Trademark Office on Feb. 24, 2005.

### BACKGROUND OF THE INVENTION

1. Technical Field

The present invention relates to an ice bucket cover and a closable ice bucket cover pouch made of a flexible, stretchable, thermally insulative material, such as neoprene.

2. Background Information

Although they may include a bucket lid to contain the cold temperature inside the bucket, conventional ice buckets do not normally include a separate cover for the outside. The present invention is a protective cover for an ice bucket that protects guests' hands and clothes from becoming wet or harmed by the cold exterior surface when they came in contact with the ice bucket. The present ice bucket cover also lessens the effects of sweating, which commonly occurs on the exterior of a full ice bucket, particularly a metal ice bucket filled with ice.

The present ice bucket cover is preferably made of neoprene, which is a flexible, durable, stable, form-fitting synthetic material. The flexibility of neoprene and its ability to “remember” the shape of the ice bucket allows the cover of the present invention to easily fit over and be removed from various ice buckets, even buckets with slightly different diameters and shapes. These characteristics also allow handle holes of the present bucket cover to easily fit over short side handles on an ice bucket. The same ice bucket cover will also fit over a similarly sized ice bucket without side handles. Neoprene is also employed herein for its insulative properties, since it tends to insulate the ice bucket and retain cold temperatures in the bucket. The neoprene is not adversely impacted by exposure to water, which is useful where the exterior surface of the ice bucket would ordinarily sweat.

### BRIEF SUMMARY OF THE INVENTION

The present invention is an ice bucket cover, including: (a) a substantially circular bottom wall; (b) a substantially cylindrically-shaped cover side wall attached at a bottom side wall edge to a periphery of the bottom wall, the side wall being made of neoprene; (c) a substantially circular, open top; (d) at least two same-sized ice bucket handle holes on opposite sides of the ice bucket cover; and (e) at least two pull tabs affixed to a top side wall edge of the ice bucket cover above the bucket handle holes, each pull tab being on an opposite side of the cover from the other pull tab; wherein the ice bucket cover is sized to closely fit over an outside surface of an ice bucket or the like.

The present ice bucket cover may simply include: (a) a substantially circular bottom wall; (b) a substantially cylindrically-shaped cover side wall attached at a bottom side wall edge to a periphery of the bottom wall; and (c) a substantially circular, open top; wherein the ice bucket cover is made of a flexible, stretchable, thermally insulative material, and sized to closely cover a major portion of an outside surface of an ice bucket.

Also included herein is an ice bucket cover pouch for enclosing and carrying a full or empty ice bucket, which includes: (a) a substantially circular bottom wall; (b) a substantially cylindrically-shaped cover side wall attached at a bottom side wall edge to a periphery of the bottom wall, the cover side wall extending substantially perpendicularly from the bottom wall, the cover side wall extending a substantial distance beyond an upper edge of the ice bucket; and (c) a closure mechanism for closing a top side wall edge of the ice bucket cover pouch. The ice bucket cover pouch includes a substantially circular, open top when the pouch is in an open position. The ice bucket cover pouch is made of neoprene and sized to closely cover the outside surface of the ice bucket.

Advantages of the ice bucket cover of the present invention include the following: (1) assists in thermally insulating beverages, food, ice, etc. within the ice bucket; (2) keeps the user's hands dry and warm; (3) fits various sizes of conventional ice buckets within a certain size range; and (4) is aesthetically appealing and can be monogrammed or otherwise illustrated. The ice bucket cover pouch herein further provides a means of closing the cover pouch over the ice bucket and carrying both.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a perspective view of an ice bucket cover, shown in use on an ice bucket;

FIG. 2 is a rear elevational view of the ice bucket cover of FIG. 1;

FIG. 3 is a bottom plan view of the ice bucket cover of FIG. 1;

FIG. 4 is a side elevational view of an ice bucket cover according to the present invention;

FIG. 5 is a top plan view of the ice bucket cover of FIG. 4;

FIG. 6 is a rear elevational view of an ice bucket cover according to the present invention;

FIG. 7 is a side elevational view of an ice bucket cover according to the present invention;

FIG. 8 is a top plan view of the ice bucket cover of FIG. 7; and

FIG. 9 is a side elevational view of an ice bucket cover according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

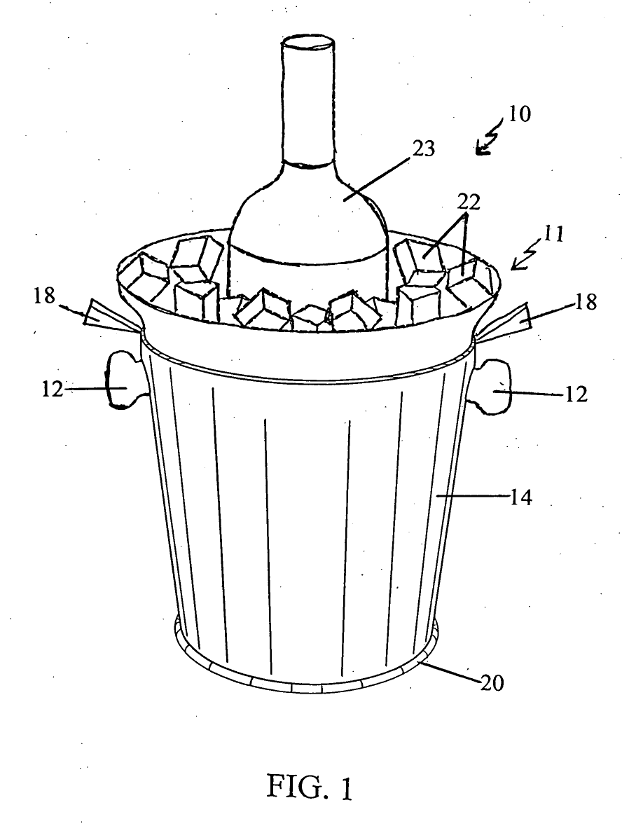

Referring to FIGS. 1 through 3, an ice bucket cover according to the present invention, generally referred to as 10, is for closely covering and insulating a conventional ice bucket 11 or the like, with or without ice bucket handles 12. The ice bucket cover 10 comprises: (a) a substantially circular bottom wall 13; (b) a substantially cylindrically-shaped cover side wall 14 attached at a bottom side wall edge 15 to a periphery of the bottom wall 13; (c) a substantially circular, open top 16; and (d) at least two same-sized ice bucket handle holes 17 on opposite sides of the ice bucket cover 10.

The ice bucket cover 10 is sized to closely fit over the outside surface of the ice bucket 11. When the ice bucket cover 10 is in use, the cover bottom wall 13 is substantially horizontally oriented, and the cover side wall 14 is substantially vertically oriented, extending substantially perpendicularly from the cover bottom wall 13, as seen in FIGS. 1-3.

The cover side wall 14 and the cover bottom wall 13 are made of a stretchable, flexible, thermally insulating material, preferably neoprene. The ice bucket cover 10 may be employed on a full or empty conventional ice bucket 11 with or without a conventional ice bucket lid (not shown). In FIG. 1, the ice bucket cover 10 is shown with ice 22 and a wine bottle 23, although any item ordinarily stored in an ice bucket and any temperature reducing source, such as ice packs, can be utilized in the ice bucket 11. In addition to helping to keep items inside the ice bucket cold, and protecting the user's hands, the neoprene cover 10 conforms to the shape of the ice bucket 11 and accommodates ice buckets of various sizes within a certain size range. For example, the neoprene cover 10 may fit a 10 or 11 inch diameter cylindrical shaped ice bucket, and also stretch to fit a 12 inch diameter ice bucket. The neoprene cover 10 is lightweight and inexpensive to ship. It retains its shape, so it is easy to store.

Since the neoprene-material is stretchy, the bucket handle holes 17 can be pulled over the bucket handles 12 without tearing the cover material at the handle holes 17. The ice bucket cover 10 thereby accommodates various bucket handle types and shapes, including knob handles and ring-shaped handles. The same ice bucket cover 10 can be used on an ice bucket 11 without handles 12, even if the cover 10 includes handle holes 17.

The neoprene cover 10 fits closely around the ice bucket 11. The close fit enhances its thermally insulative properties and makes the cover 10 less likely to slip around on the ice bucket 11, even if the ice bucket 11 sweats on the outside. The neoprene cover 10 does not have to have a nonskid inside coating applied to prevent it from slipping. The neoprene material may be laminated. However, there is no need to go through the extra expense of layering it with other insulative materials, such as rubberized latex, since a single neoprene layer cover is relatively inexpensive and works well by itself.

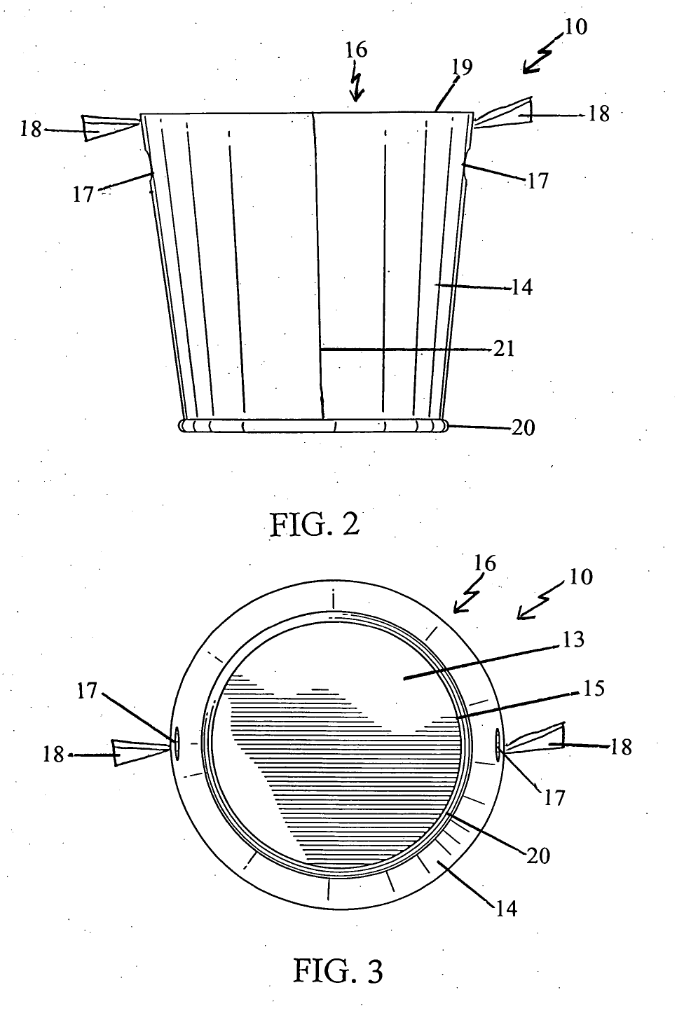

The cover 10 is preferably made of two pieces. The cover side wall 14 is preferably made from a single rectangular-shaped piece of neoprene, which is sewn, bonded, or otherwise joined to form a rear seam 21. The rear seam 21 extends in a generally vertical direction when the cover 10 is in use as seen in FIG. 2. The bottom side wall edge 15 is sewn or otherwise suitably attached to the periphery of the circular-shaped bottom wall 13.

The ice bucket cover 10 further includes piping 20, which extends around a periphery of the seam between the bottom cover wall 13 and the bottom side wall edge 15, as shown in FIGS. 1 through 3. The piping 20 stabilizes the ice bucket cover 10 when it is in use, and it helps the user to pull the ice bucket cover 10 up over the ice bucket 11, which is usually a tight fit.

To use the cover 10, the user slides the ice bucket 11 down through the open cover top 16, pulling the ice bucket cover 10 up by its top side wall edge 19, or pull tabs 18, until the bottom of the ice bucket rests on the cover bottom wall 13. If there are handles 12 on the ice-bucket, the user pulls the cover 10 out and over each bucket handle 12 so that the cover handle holes 17 fit over the bucket handles 12.

The ice bucket cover 10 preferably further includes at least two pull tabs 18 on opposite sides of the cover 10. The pull tabs 18 are affixed at one end to a top side wall edge 19 of the ice bucket cover 10 above the bucket handle hole 17. As seen in FIGS. 1-3, each pull tab 18 is on an opposite side of the cover from the other pull tab. Since the bucket holes 17 fit tightly around the handles 12, it can be relatively difficult to grab the neoprene cover material and pull it away from the ice bucket 11. The pull tabs 18 make it easier to pull the cover material away from the side of the ice bucket 11. The convenient pull tabs 18, which may be in the form of pull loops, make it easier for a host to enjoy preparations for and cleanup after the party or other function at which the ice bucket is used.

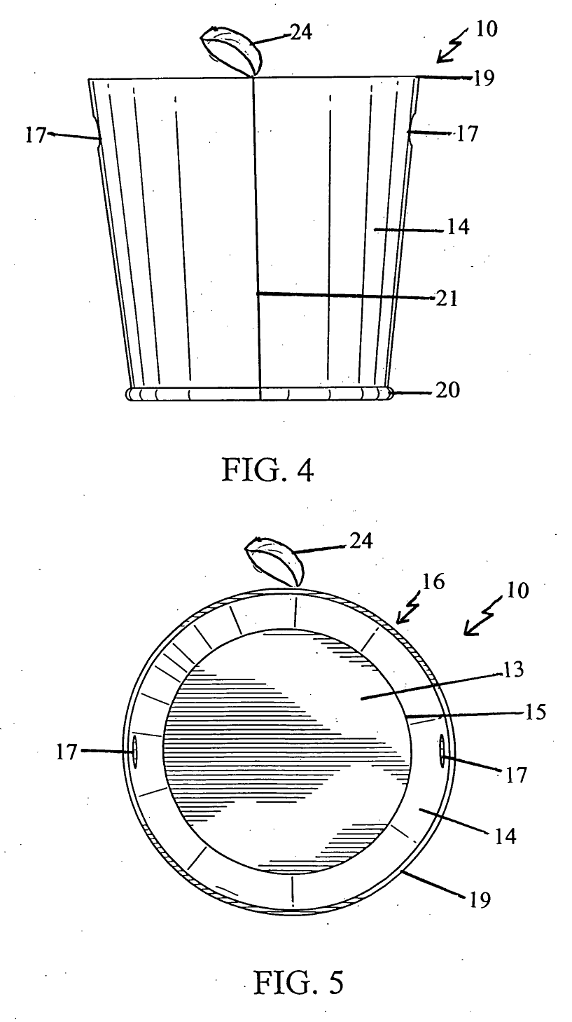

As illustrated in FIGS. 4 and 5, the neoprene ice bucket cover 10, includes: (a) the substantially circular bottom wall 13; (b) the substantially cylindrically-shaped cover side wall 14 attached at a bottom side wall edge 15 to a periphery of the bottom wall 13; (c) the substantially circular, open top 16; and (d) at least one pull loop 24 affixed to a top side wall edge 19 of the ice bucket cover 10. As shown in FIGS. 4 and 5, the cover 10 also includes at least two ice bucket handle holes 17 on opposite sides of the ice bucket cover 10. The cover 10 is sized to closely cover a major portion of an outside surface of an ice bucket, as shown in FIG. 1. Preferably, the cover side wall 14 includes the vertically oriented seam 21 substantially midway between the two ice bucket handle holes 17, and the end of the pull loop 24 is attached to a top end of the vertically oriented seam 21. The cover bottom wall 13 is substantially horizontally oriented, and the cover side wall 14 is substantially vertically oriented, when the ice bucket cover 10 is in use.

Since the cover material is tight, it can be difficult to pull up or down, particularly once sweat from the ice bucket 11 has made it more difficult to pull down the ice bucket cover 10. Even where there is only one, the pull loop 24 is surprisingly effective in breaking the surface tension between the ice bucket 11 and the cover material, facilitating separation of the two. Pulling the pull loop 24 generally downward and away from the ice bucket 11 causes the top edge 19 of the neoprene cover 10 to begin to roll down. Once it starts to roll, it is relatively easy to remove the rest of the way.

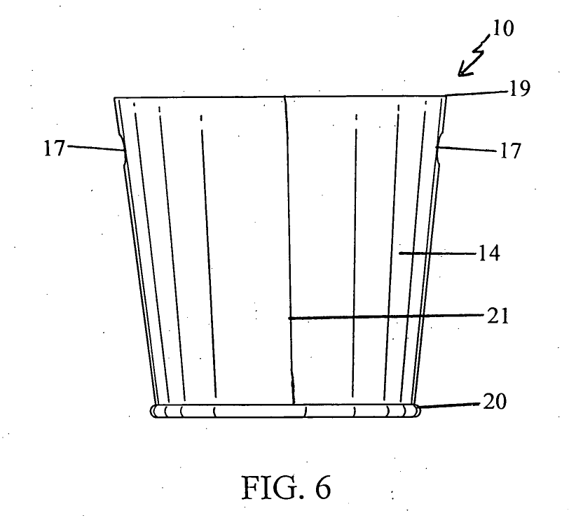

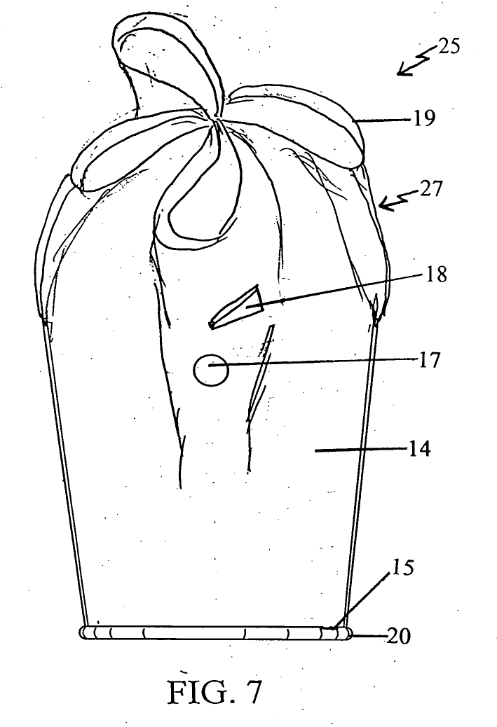

Referring to FIG. 6, the ice bucket cover 10 may simply include: (a) the substantially circular bottom wall 13; (b) the substantially cylindrically-shaped cover side wall 14 attached at a bottom side wall edge 15 to a periphery of the bottom wall 13; (c) the substantially circular, open top 16. The ice bucket cover 10 shown in FIG. 6 is made of a flexible, stretchable, thermally insulative material, and sized to closely cover a major portion of the outside surface of the ice bucket 11. The front and rear of the cover 10 of FIG. 6 look alike, except that the rear includes a side wall seam 21. The ice bucket cover 10 depicted in FIG. 6 does not include a pull tab 18 or loop 24, as shown in the previous figures.

The ice bucket cover 10 is not adhered to the outside surface of the ice bucket 11, and does not require any means of attachment around the ice bucket 11 (such as a strap, hook and loop strips, or a zipper) in order to accommodate the ice bucket. Although a zipper can be attached within the side wall seam 21, the ice bucket cover 10 does not require, and therefore preferably does not include, a vertically oriented zipper.

Turning now to FIGS. 7-9, the ice bucket cover 10 may be an ice bucket cover pouch 25, which can be used to carry a full or empty conventional ice bucket with or without an ice bucket lid. If the ice bucket has a bucket lid, the bucket lid can be placed over the ice bucket once it has been inserted into the pouch 25, and the pouch can be closed over it. The closed cover pouch 25 prevents ice from spilling from the ice bucket on the way to and from an ice machine. It also allows a full or empty ice bucket to be carried to and from a party or other event. The cans, bottle, or other beverage or food containers can be inserted in the ice bucket along with the ice or other cold source before the pouch 25 has been closed and stored until use, or the containers can be inserted into the ice after the pouch 25 has been opened (at the party, for example).

The ice bucket cover pouch 25 includes: (a) the substantially circular bottom wall 13; (b) the substantially cylindrically-shaped cover side wall 14 attached at a bottom side wall edge 15 to a periphery of the bottom wall 13, the cover side wall 14 extending substantially perpendicularly from the bottom wall 13; (c) a closure mechanism 26, 28 for closing a top side wall edge 19 of the ice bucket cover pouch 25. The ice bucket cover pouch 25 has a substantially circular, open top 16 when the pouch 25 is in an open position. The ice bucket cover pouch 25 is made of neoprene or another flexible, stretchable, thermally insulative material, and is sized to closely cover an outside surface of the ice bucket. The cover side wall 14 extends a substantial distance above and beyond the upper edge of the ice bucket, leaving a loose area 27 of the neoprene material over the top of the ice bucket. The cover pouch optionally includes a carry strap (not shown) with its ends attached to the outside of the cover on either side of the cover.

The ice bucket cover pouch 25 further comprises a piping 20 extending around a periphery of the circular seam between the bottom cover wall and the bottom side wall edge. The piping 20, or beading, and relatively stiff cover material allows the pouch 25 to be free-standing (stands on its bottom wall on its own on a relatively flat surface), even when it is not in use. This facilitates insertion of the ice bucket and presents an attractive appearance, particularly where the cover pouch 25 has a cover design.

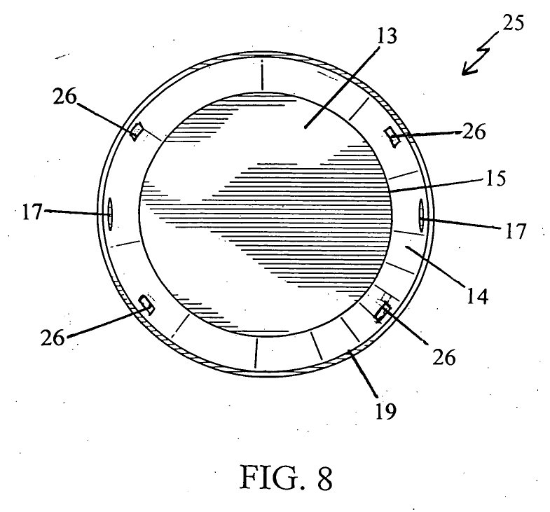

The ice bucket cover pouch 25 shown in FIGS. 7 and 8 also includes hook and loop material 26. Corresponding hook and loop strips 26 are attached to the inside face of the pouch 25, as indicated in FIG. 8. Once the pouch 25 has been pulled up over the ice bucket, the user pinches the sides of the generally circular top side wall edge 19 (loose area 27) towards one another to form a cross-shape (in plan view), as illustrated in FIG. 7. Squeezing the sides of the loose area 27 of the pouch 25 together causes the corresponding hook and loop strips 26 on opposite sides inside the pouch 25 to attach to one another, which closes the pouch 25, as shown in FIG. 7.

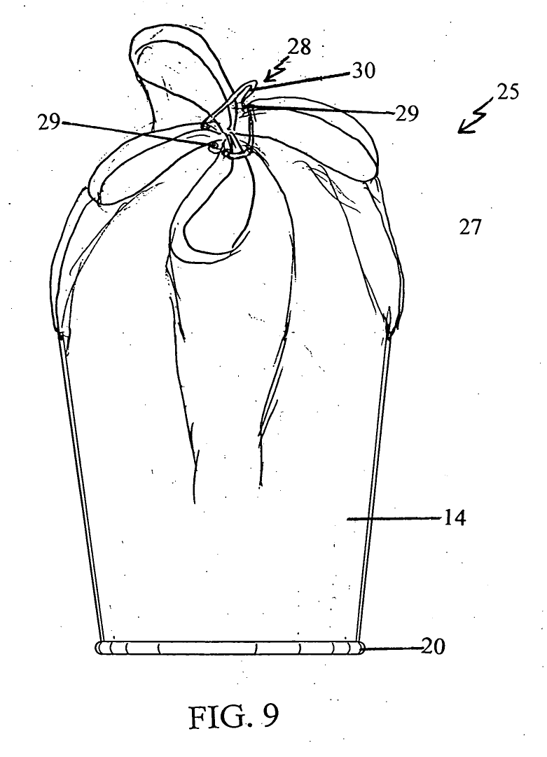

The pouch may (see FIGS. 7 and 8) or may not (see FIG. 9) include holes 17 for ice bucket handles. As shown in FIG. 7, the ice bucket cover pouch 25 optionally further includes at least two of the pull tabs 18. Each pull tab 18 is affixed to an outside face of the ice bucket cover pouch 25 on an opposite side of the cover from the other pull tab between the bucket handle hole 17 and the loose area 27.

The ice bucket cover pouch 25 shown in FIG. 9 is also closable. Here, the closure mechanism 28 comprises at least one lace 29 and a number of spaced apart lace holes 30 in the top side wall edge 19. Once the top side wall edge 19 has been squeezed together as described above, the lace 29 (e.g., ribbon) is threaded through the lace holes 30 punched in the cover material. Since the cover pouch 25 is strong and durable, the lace 29 or laces can be used to carry the cover pouch 25 once it has been closed, even with the ice bucket inside.

The ice bucket cover 10 or cover pouch 25 herein preferably includes advertising or any suitable design, logo, and/or message on its outside face. The ice bucket cover 10 is preferably monogrammed by placing it over a sleeve on a monogramming machine prior to use. If desired, a ribbon (not shown) can be fastened around the top outside edge of the cover above the bucket handles, once the cover is on the ice bucket, and tied into a bow. The slightly rough texture of the neoprene material prevents most ribbon material from slipping and helps to keep the bow tied.

From the foregoing it can be realized that the described device of the present invention may be easily and conveniently utilized as. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 ice bucket cover
11 ice bucket
12 ice bucket handles
13 bottom wall
14 cover side wall
15 bottom side wall edge
16 open top
17 ice bucket handle holes
18 pull tabs
19 top side wall edge
20 piping
21 side wall seam
22 ice
23 bottle
24 pull loop
25 ice bucket cover pouch
26 hook and loop strips
27 loose area of pouch
28 closure mechanism
29 pouch lace holes
30 pouch lace

What is claimed is:

1. An ice bucket cover, comprising:
(a) a substantially circular bottom wall;
(b) a substantially cylindrically-shaped cover side wall attached at a bottom side wall edge to a periphery of the bottom wall, the cover side wall being made of neoprene;
(c) a substantially circular, open top;
(d) at least two same-sized ice bucket handle holes on opposite sides of the ice bucket cover; and
(e) at least two pull tabs affixed to a top side wall edge of the ice bucket cover above the bucket handle hole, each pull tab being on an opposite side from the other pull tab;
wherein the ice bucket cover is sized to closely fit over an outside surface of an ice bucket.

2. The ice bucket cover according to claim 1, further comprising piping extending around a periphery of a circular seam between the bottom cover wall and the bottom side wall edge.

3. The ice bucket cover according to claim 1, wherein the bottom wall is substantially horizontally oriented, and the side wall is substantially vertically oriented when the ice bucket cover is in use.

4. The ice bucket cover according to claim 1, wherein the cover bottom wall is made of neoprene.

5. An ice bucket cover, comprising:
(a) a substantially circular bottom wall;
(b) a substantially cylindrically-shaped cover side wall attached at a bottom side wall edge to a periphery of the bottom wall; and
(c) a substantially circular, open top;
wherein the ice bucket cover is made of a flexible, stretchable, thermally insulative material, and sized to closely cover a major portion of an outside surface of an ice bucket.

6. The ice bucket cover according to claim 5, further comprising: (d) at least one pull loop, an end of the pull loop being affixed to a top side wall edge of the ice bucket cover.

7. The ice bucket cover according to claim 6, further comprising: (e) at least two ice bucket handle holes on opposite sides of the ice bucket cover.

8. The ice bucket cover according to claim 7, wherein the bottom wall is substantially horizontally oriented, and the side wall is substantially vertically oriented when the ice bucket cover is in use.

9. The ice bucket cover according to claim 7, wherein the side wall comprises a vertically oriented seam substantially midway between the two ice bucket handle holes, and the pull loop is attached to a top end of the seam.

10. An ice bucket cover pouch for enclosing and carrying a full or empty ice bucket, the pouch comprising:
(a) a substantially circular bottom wall;
(b) a substantially cylindrically-shaped cover side wall attached at a bottom side wall edge to a periphery of the bottom wall, the cover side wall extending substantially perpendicularly from the bottom wall, the cover side wall extending a substantial distance beyond an upper edge of the ice bucket; and
(c) a closure mechanism for closing a top side wall edge of the ice bucket cover pouch;
wherein the ice bucket cover pouch comprises a substantially circular, open top when the pouch is in an open position; and wherein the ice bucket cover pouch is made of neoprene and sized to closely cover an outside surface of the ice bucket.

11. The ice bucket cover pouch according to claim 10, wherein the closure mechanism comprises a plurality of lace holes in a periphery of the cover side wall, and at least one lace insertable through the top edge holes.

12. The ice bucket cover pouch according to claim 10, wherein the closure mechanism is a plurality of corresponding lock and loop strips attached to an inside face of the pouch around a periphery of the pouch.

13. The ice bucket cover pouch according to claim 12, further comprising at least two ice bucket handle holes on opposite sides of the ice bucket cover.

14. The ice bucket cover pouch according to claim 13, further comprising at least two pull tabs, each pull tab being affixed to an outside face of the ice bucket cover pouch on an opposite side from the other pull tab between the bucket handle hole and the top side wall edge.

15. The ice bucket cover pouch according to claim 13, wherein the bottom wall is substantially horizontally oriented, and the side wall is substantially vertically oriented when the ice bucket cover is in use.

16. The ice bucket cover pouch according to claim 10, further comprising piping extending around a periphery of a circular seam between the bottom cover wall and the bottom side wall edge.

17. The ice bucket cover pouch according to claim 16, wherein the pouch is free-standing even when it is not in use.
